(19) United States
(12) Patent Application Publication
(10) Pub. No.: US 2024/0354075 A1
(43) Pub. Date: Oct. 24, 2024

(54) Method for Providing Access From at Least One Vehicle Software Application to at Least One of Different Vehicle Systems

(71) Applicant: Robert Bosch GmbH, Stuttgart (DE)

(72) Inventors: Mathias Danzeisen, Stuttgart (DE); Emily Ruppel, Pittsburgh, PA (US); Jochen Kienzle, Korntal (DE)

(21) Appl. No.: 18/637,103

(22) Filed: Apr. 16, 2024

(30) Foreign Application Priority Data
Apr. 20, 2023 (DE) 10 2023 203 665.7

(51) Int. Cl. G06F 8/41

(52) U.S. Cl. CPC G06F 8/41

(57) ABSTRACT

A method is for providing access from at least one vehicle software application to at least one of different vehicle systems. The vehicle systems include differently configured electrical/electronic architecture. The electrical/electronic architecture includes at least one data processing device configured to execute the at least one vehicle software application for providing functions and/or data. The electrical/electronic architecture is configured to provide further vehicle functions and/or vehicle data in addition to the functions and/or data provided by the at least one data processing device. The method includes providing the vehicle software application. The vehicle software application is configured to be executed in runtime environments of the at least one data processing device. The method also includes providing an access interface to the runtime environments for the vehicle software application. The access interface is defined by an interface description language.

This application claims priority under 35 U.S.C. § 119 to patent application no. DE 10 2023 203 665.7, filed on Apr. 20, 2023 in Germany, the disclosure of which is incorporated herein by reference in its entirety.

The disclosure relates to a method for providing access from at least one vehicle software application to at least one of different vehicle systems. Furthermore, the disclosure relates to a computer program, a device and a storage medium for this purpose, as well as to a method for providing at least one vehicle software application for at least one of different vehicle systems.

### BACKGROUND

It is known from the prior art that vehicle software applications are executed on vehicle computers and thus need to be adapted to the specific vehicle itself. In order for vehicle manufacturers or their suppliers to develop these vehicle software applications as efficiently as possible, it is known to design such applications to be at least partially reusable and portable on different vehicle electrical/electronic architectures and data processing devices. Portability is often achieved by decoupling vehicle hardware and software with different middleware stacks (such as Adaptive AUTOSAR) or communication stacks (such as grpc, Some/IP).

WebAssembly (Wasm) is a technology originating from the area of web browsers. By just-in-time-compilation of Wasm modules, they are independent of the hardware architecture (e.g. x86, ARM, RISC V . . . ). However, these modules cannot access system interfaces and hardware for security reasons. According to an innovation, the WebAssembly component model in particular makes it possible to provide modules with access to the system depending on their respective requirements. Furthermore, WIT describes a basis of common interfaces as an interface description language. Custom interfaces can be described with WIT in the WIT format and used for generating code with Wasm modules and the Wasm runtime.

A particular disadvantage of the known solutions is that the interoperability of the vehicle software applications is limited by platforms such as AUTOSAR Adaptive, communication protocols such as grpc or SomeIP and a specific hardware architecture of the data processing device.

### SUMMARY

Features and details which are described in connection with a method according to the disclosure will of course also apply in connection with the computer program according to the disclosure, the device according to the disclosure and the computer-readable storage medium according to the disclosure and vice versa, so that mutual reference is or can always be made with respect to the disclosure of the individual aspects of the disclosure.

The object of the disclosure is a method for providing access from at least one vehicle software application to at least one (or several) of different vehicle systems, wherein the vehicle systems are designed with differently configured electrical/electronic architecture. The respective electrical/electronic architecture may comprise at least one data processing device suitable for executing the vehicle software application for providing these functions and/or data. In addition to the functions and/or data provided by the data processing device, the respective electrical/electronic architecture may also provide further vehicle functions and/or vehicle data.

The method may comprise the following steps, which are preferably carried out successively and/or repeatedly:
providing the vehicle software application, wherein the vehicle software application may be suitable to be executed in runtime environments of the different data processing devices,
providing (at least) one access interface to the runtime environments for the vehicle software application, wherein the access interface is defined by means of an interface description language, wherein the access interface may be defined by means of the interface description language for access to the functions and/or data as well as the further vehicle functions and/or vehicle data, wherein the access interface can be defined as suitable for the different configurations and in particular independent of the specific configuration of the electrical/electronic architecture.

In the context of the disclosure, the term “access” preferably describes that different data in the vehicle system can be written and read by the vehicle software application, and that different functions can be executed by the vehicle software application in the vehicle system using the access interfaces. A vehicle software application may be any vehicle-related application, such as a navigation software application or entertainment software application and/or software used for at least semi-autonomous driving of a vehicle. In the context of the disclosure, a vehicle system can be understood as an embodiment of the entire hardware and software of a vehicle. An electrical/electronic architecture within the vehicle system represents an association and a precise specification of the electrical and electronic components of the vehicle system. This includes, for example, wiring harnesses, data processing devices, sensors, and actuators. According to the disclosure, a data processing device is, for example, a computer or a microprocessor. In the context of the disclosure, functions may be, for example, seat adjustment or windscreen wiping. According to the disclosure, data incudes, for example, a tire pressure, an engine speed or a location of the vehicle system. The further vehicle functions and/or vehicle data are preferably to be understood as not being directly available in the runtime environment of the data processing device or not being directly executed with the data processing device on which the vehicle software application is executed. For example, the further vehicle functions and/or vehicle data are only indirectly available via another data processing device. In the context of the disclosure, a runtime environment is in particular a type of operating system for loading and linking vehicle software applications. An access interface may be a connection point to a data processing device or to a component, for example a sensor or actuator. The access interface is preferably used for unidirectional or bidirectional data transfer, or communication. In the context of the disclosure, an interface description language, such as WIT, is in particular a declarative formal language and includes language syntax for describing interfaces of a software component. The access interface is thereby preferably suitable for the different configurations of the electrical/electronic architecture, and in particular independently of the specific configuration of the electrical/electronic architecture in that the access interface can be defined accordingly by the interface language. The definition of the access interface may include a use of a standardized syntax.

The access interface may be a so-called WASI interface. WASI stands for “WebAssembly System Interface” and is an interface that allows WebAssembly modules to be run in an isolated and secure environment. WASI may allow WebAssembly modules to be run on an operating system in a similar way to native applications without direct access to the operating system or hardware of the host system. WASI defines a series of system calls that are available in a WebAssembly module, such as opening a file, writing data to a file, or reading input data. These system calls are provided by a runtime environment that the module or data processing device executes. The advantages of WASI are that WebAssembly modules can be run in a standardized and secure environment regardless of the operating system and hardware on which they run. This makes it easier to run WebAssembly modules on different platforms and to integrate them into existing systems. Advantageously, the vehicle software application according to the disclosure is portable due to the above features, whereby the vehicle software application can be executed on a wide variety of data processing devices and electrical/electronic architectures.

In a further possibility, it can be provided that the electrical/electronic architecture comprises at least one sensor and/or actuator and preferably at least one further data processing device, which is in particular used at least in part for at least semi-autonomous driving and/or for controlling the at least one actuator and/or for reading the at least one sensor, wherein preferably the vehicle software application initiates control and/or reading. For example, the at least one or more sensors are speed sensors, rotational speed sensors, exhaust gas sensors or rain sensors, wherein this list is not exhaustive. For example, the at least one or more actuators are headlights, brakes, steering, air conditioning, and loudspeakers of the vehicle system, wherein this list is not exhaustive. Multiple sensors can help improve safety: By employing multiple sensors such as cameras, radar, ultrasound, etc. in a vehicle, they can help detect obstacles, measure distances, monitor lane guidance, avoid collisions, etc. This helps reduce the risk of accidents and injuries. Actuators enable more precise control: The more actuators present in a vehicle, the more finely the vehicle can be controlled. An example of this is steering: If the vehicle has electronically assisted steering, the assistance may be adapted to the particular driving situation to allow for better handling. Multiple sensors and actuators may help improve efficiency: By using sensors and actuators, vehicle functions can be optimized resulting in higher efficiency. For example, the engine controller may be improved by using sensors such as the air mass sensor or the throttle valve sensor, resulting in higher fuel efficiency. Thus, in the context of the disclosure, with a high number of sensors and actuators, the vehicle software applications can provide a wide range of functions that lead to the above-mentioned advantages. Further data processing devices may further increase computational efficiency, for example by running vehicle software applications in parallel.

Advantageously, the disclosure may provide that the functions and the further vehicle functions comprise controls, regulations, and/or measurements internal to the vehicle system and/or connected to the vehicle system, and the data and further vehicle data comprise measurement data from at least one sensor internal to the vehicle system and/or a sensor connected to the vehicle system, wherein the respective electrical/electronic architecture and in particular the runtime environments comprise a switching function, to provide access to the further vehicle functions and/or vehicle data via the access interface defined independently of the different configurations of the electrical/electronic architecture. Controllers, regulators, and/or measurements associated with the vehicle system may be provided via, for example, a smartphone, an off-board computer or a communication with a server or satellite located outside of the vehicle system. The same applies to the sensors associated with the vehicle system, such that GPS navigation via satellite data or data of a sensor of an external computer connected to the vehicle system, for example, is provided. The switching function may be provided by defining the interfaces using the interface description language. In a simplified formulation, the independence from the different configurations of the components of the electrical/electronic architectures is achieved by translating the software implementation specifically necessary for a particular access interface into a universally applicable language, in particular with the aid of the interface description language used according to the disclosure.

It also advantageous if the vehicle software application is provided by a WebAssembly byte code, in particular as a Wasm component, in particular to execute the vehicle software application portably on different data processing devices. For example, the WebAssembly byte code consists of a sequence of instructions that may be executed on the WebAssembly engine. The WebAssembly instructions may be designed to be executed in a simple and efficient manner. As the WebAssembly byte code is platform-independent, it may be run in different environments. This makes it possible to compile and execute a programming language such as C or C++ on different platforms without having to make specific adjustments to each platform.

Advantageously, it may be provided that the access interface is additionally defined by means of the interface description language using a vehicle signal and/or vehicle service specification for access to the functions and/or data as well as to the further vehicle functions and vehicle data, wherein the vehicle signal and/or vehicle service specification provides a syntax to structure and standardize vehicle signals and vehicle services within the context of the vehicle software application. The vehicle signal and/or vehicle service specification may significantly increase the number of options for the vehicle software application to access different access interfaces, as the specifications provide a plurality of standardized signal and service descriptions.

The subject matter of the disclosure is in particular a further method for providing at least one vehicle software application to at least one or more of different vehicle systems, wherein the vehicle systems may be designed with differently configured electrical/electronic architecture, wherein the respective electrical/electronic architecture can comprise at least one data processing device suitable for executing the vehicle software application for providing functions and/or data, and wherein the respective electrical/electronic architecture may provide further vehicle functions and/or vehicle data in addition to the functions and/or data provided by the data processing device, comprising the following steps. The further method may comprise the following steps, which are preferably carried out successively and/or repeatedly:
providing a vehicle signal and/or a vehicle service specification,
converting the vehicle signal and/or the vehicle service specification to provide the vehicle signal and/or the vehicle service specification compatible for use in an interface description language,
generating at least one interface description for at least one access interface by means of the interface description language, wherein the at least one access interface is provided to access the functions and/or data as well as the further vehicle functions and/or vehicle data,
generating the at least one vehicle software application using the at least one interface description generated.

Converting the vehicle signal and/or the vehicle service specification may be performed by a software tool suitable for this purpose. The at least one interface description for at least one access interface is generated, in particular using the converted vehicle signal and/or vehicle service specification, such that a plurality of descriptions are provided by different access interfaces. The generation of at least one vehicle software application using the at least one interface description generated may be executed in a corresponding development environment.

It may also be possible that the method further comprises one of the following steps:
converting the interface description to use the interface description in a desired programming language, in particular Java, C, C++ or Rust, to generate the vehicle software application in the desired programming language,
compiling the generated vehicle software application,
selecting a runtime environment of the at least one data processing device to execute the compiled vehicle software application on the selected runtime environment.

For example, WIT-bindgen is used to convert the interface description. By means of WIT-bindgen, the runtime environment on which the vehicle software application is to be executed can also be selected.

It is possible that at least one of the methods according to the disclosure is used in a vehicle. The vehicle can, for example, be designed as a motor vehicle and/or a passenger vehicle and/or an autonomous vehicle. The vehicle can comprise a vehicle device, e.g., for providing an autonomous driving function and/or a driver assistance system. The vehicle device can be designed to control and/or accelerate and/or brake and/or steer the vehicle, at least partially automatically.

Moreover, the methods according to the disclosure can also be configured as a computer-implemented method.

The disclosure also relates to a computer program, in particular a computer program product, comprising instructions that, when the computer program is executed by a computer, cause said computer program to perform at least one of the methods according to the disclosure. The computer program according to the disclosure thus brings with it the same advantages as have been described in detail with reference to a method according to the disclosure.

The disclosure also relates to a device for data processing which is configured to carry out at least one of the methods according to the disclosure. The device can be a microcontroller or a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, cause said computer program to perform at least one of the methods according to the disclosure. The storage medium is configured as a data memory such as a hard drive and/or a non-volatile memory and/or a memory card, for example. The storage medium can, for example, be integrated into the computer.

### BRIEF DESCRIPTION OF THE DRAWINGS

Further advantages, features and details of the disclosure will emerge from the following description, in which embodiment examples of the disclosure are described in detail with reference to the drawings. The features mentioned in the claims and in the description can each be essential to the disclosure individually or in any combination. The figures show:

FIG. 1-A schematic illustration of a possible embodiment of a method according to the disclosure and a computer program, a data processing device and a computer-readable storage medium according to exemplary embodiments of the disclosure,

FIG. 2-A schematic representation of a possible embodiment of a method according to exemplary embodiments of the disclosure,

FIG. 3-A schematic representation of a possible embodiment of a vehicle system according to exemplary embodiments of the disclosure, and

FIG. 4-A schematic representation of a further possible embodiment of a method according to exemplary embodiments of the disclosure.

### DETAILED DESCRIPTION

In the figures, identical reference signs are used for the same technical features even of different exemplary embodiments.

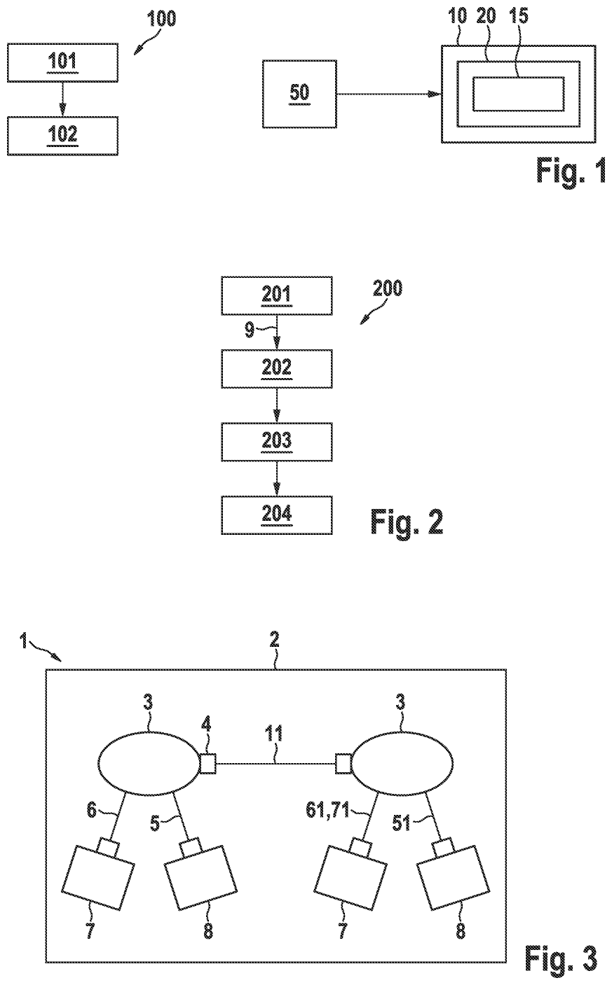

FIG. 1 schematically shows a method 100, a vehicle software application 50, a device 10, a storage medium 20 and a computer program 15 according to exemplary embodiments of the disclosure.

According to exemplary embodiments of the disclosure, a vehicle software application 50 is initially provided in a first method step 101. The vehicle software application 50 is suitable for being executed in runtime environments 31 of different data processing devices 3. In a second method step 102, an access interface 4 to the runtime environments 31 for the vehicle software application 50 is provided. For this purpose, the access interface 4 is defined by means of an interface description language. The definition of the access interface 4 by means of an interface description language includes access to functions 5 and/or data 6 of the data processing device 3 as well as further vehicle functions 51 and/or vehicle data 61. The access interface 4 is further suitable for different configurations of the electrical/electronic architecture 2 of the vehicle system 1 and, in particular independently of the specific configuration of the electrical/electronic architecture 2 of the vehicle system 1. The vehicle system 1, which comprises an electrical/electronic architecture 2, is shown in FIG. 3.

FIG. 2 shows schematically a further method 200 according to exemplary embodiments of the disclosure. Here, in a first method step 201, a vehicle signal and/or a vehicle service specification 9 is provided. The vehicle signal and/or vehicle service specification 9 provides a specific syntax for defining and using vehicle signals and/or vehicle services in a structured and standardized manner within the context of the vehicle software application 50. The vehicle signal and/or vehicle service specification 9 is converted in a second method step 202 to provide the vehicle signal and/or the vehicle service specification 9 in particular compatible for use in an interface description language. By means of the interface description language, an interface description for at least one access interface 4 can be generated in a third method step 203. The at least one access interface 4 is provided to access the functions 5 and/or data 6 as well as the further vehicle functions 51 and/or vehicle data 61. In a fourth method step 204, at least one vehicle software application 50 is generated using the at least one interface description generated.

The method 200 can optionally comprise further method steps, for example a conversion of the interface description to use the interface description in a desired programming language 208, for example Java, C, C++ or Rust, to generate the vehicle software application 50 in the desired programming language 208. Furthermore, compiling 209 the generated vehicle software application 50 may be provided. In addition a selection 210 of the runtime environment 31 of the at least one data processing device 3 can be made to execute the compiled vehicle software application 50 on the selected runtime environment 31.

FIG. 3 schematically shows a possible embodiment of a vehicle system 1 according to exemplary embodiments of the disclosure. The vehicle system 1 comprises an electrical/electronic architecture 2, which in turn can be configured differently depending on the vehicle system 1 at hand. The electrical/electronic architecture 2 comprises different components, for example data processing devices 3, sensors 7, actuators 8 and access interfaces 4 of the respective components. The access interfaces 4 are shown only schematically in FIG. 3 and can be configured as software interfaces, for example in a data processing device 3. The components are each connected via connections 11, which can be embodied as a cable connection or as a radio connection. The data processing device may provide a runtime environment 31 on which a vehicle software application 50 may be executed. The vehicle software application 50 may perform different functions 5, for example actuating an actuator 8 such as a power window or windscreen wiper. Furthermore, data 6 of the sensors 7 may be read. The access interfaces 4 are defined in the vehicle software application 50 via an interface description language. Thus, a data processing device 3 may advantageously access different functions 5 and/or data 6, as well as further vehicle functions 51 and/or vehicle data 61. For example, the further vehicle functions 51 and/or vehicle data 61 are indirectly provided via a further data processing device 3. For example, the data 6 and the further vehicle data 61 are measurement data 71 of a sensor 7.

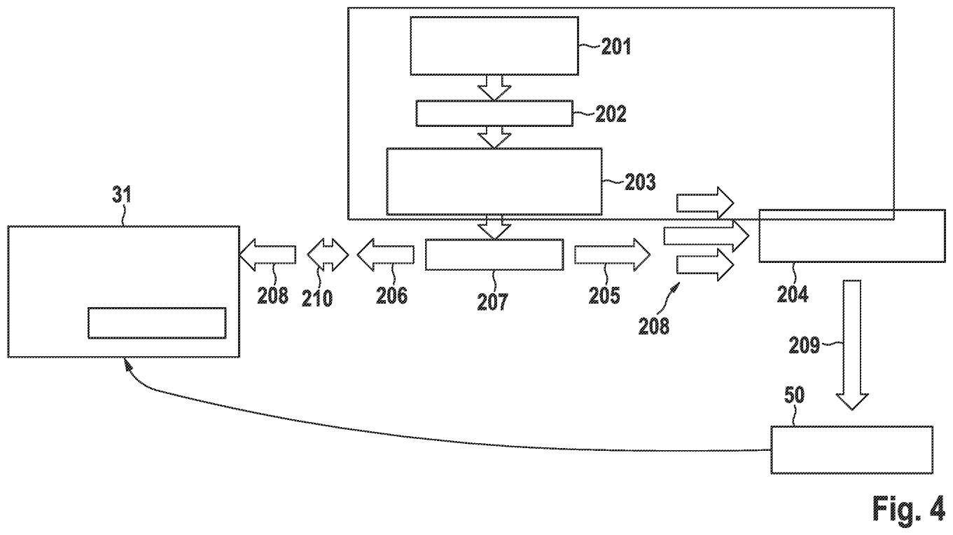

In the description below, specific terms of a possible embodiment are explained with reference to FIG. 4. Thus, a component in the context of the disclosure may be understood synonymously with a vehicle software application 50. The runtime environment 31 may be configured as “wasmtime”. Furthermore, the interface description language according to exemplary embodiments of the disclosure may be configured as a “WIT” (WebAssembly Interface). In the context of the disclosure, the terms “interface” and “access interface” may be understood synonymously.

WebAssembly, or Wasm for short, in particular defines a byte code for executing programs. The development of Webassembly code is possible in a number of programming languages 208. In addition to the byte code (wasm), there is a text form (wat) from which the byte code can be generated directly with the aid of the wat2wasm command.

Generally, byte code may be a collection of instructions for a virtual machine. For example, when compiling a source code of some programming languages 208 or environments, such as Java or C#, an intermediate code of the byte code, is created rather than machine code directly. This code is typically independent of real-world hardware. The use of byte code makes it possible to use the same virtual machine for multiple languages. It is a particular advantage of WebAssembly that the byte code can be developed for a particular use regardless of a specific language.

The WebAssembly core specification defines a format for representing executable code independent of the architecture, platform, and language. A WebAssembly module may be a compiled executable computer code. A WebAssembly module may import elements such as functions, global variables, and the like from a runtime environment 31 of the host 206 and export them to the host 206.

Moreover, it is known in connection with WebAssembly that components 50 are used to enable communication of modules. This can avoid modules having to be statically linked at creation time and not dynamically at runtime. For this purpose, module interfaces in the form of high-level types such as strings, records, collections, etc. can be defined, for example, via interface types independent of language. Module and component links can also be used to enable dynamic combination of modules into components 50. In other words: A component 50 may thus correspond to an executable file, whereas a module may correspond to a shared library. An instance of a component 50 can be referred to as a process, i.e., the running form of a component 50, which can be state-dependent and dynamic.

The Wasm runtime 31, such as “Wasmtime”, as a “runtime”, i.e., a type of operating system, may be responsible for loading and linking components 50 and mediating communications between them. Unlike most operating systems that offer a few low-level communication methods between processes (e.g., pipes, stdin/stdout, etc.), a component-capable wasm runtime 31 may provide a single high-level communication method that is based on interface types and a canonical ABI. The canonical ABI can be used to convert between the values and functions of components 50 in the component model and the values and functions of modules in Core WebAssembly. However, the component module may not specify a standard ABI for component internal communication across module boundaries. This means that modules that are to be linked within a component 50 must agree on a suitable ABI, which can be either language-specific or language-independent. The component model may be designed such that communication between components 50 as well as between modules is easily possible.

It may be a goal in component development that a component 50 can be imported from other WebAssembly modules that may be written in other programming languages 208. By defining the access interface 4, it is possible to determine what the public API is that this component 50 will implement. This can be done using WIT (WebAssembly Interface), a text format used for defining wasm interfaces. Using this WIT interface, programs such as wit-bindgen 207 can be used to create so-called bindings for the programming language 208, e.g. Rust-bindings by means of “wit-bindgen-rust”.

The Wasm Interface Type (WIT) format is in particular an IDL (i.e., an interface description language or interface definition language) for providing tools for the WebAssembly component model in two main directions: 1. It may form a format for describing the imports and exports of a component 50. It is easy to read and write and is the foundation for creating components 50 from guest languages as well as using components 50 in host languages. 2. WIT packages may form the basis for the shared use of types and definitions in an ecosystem of components 50. Developers can import types from other WIT packages when creating a component 50, publish a WIT package representing a host embedding, or collaborate on a WIT definition of a common set of APIs between platforms. A WIT package is a collection of WIT documents. In particular, each WIT document is defined in a file that uses the file extension wit, e.g. foo.wit, and may be encoded as valid utf-8-bytes. Each WIT document may contain a collection of interfaces and worlds. The concept of an “interface” is central to WIT as a collection of functions and types. An interface can be considered an instance in the WebAssembly component model, e.g. as a unit of functions imported from the host 206 or implemented by a component 50 for use on a host 206. All functions and types can belong to one interface. Types can be imported from sibling documents (files) within a package and additionally from other packages via URLs.

A WIT interface can be considered an instance in the WebAssembly component model, e.g. as a unit of functionality imported from the host 206 or implemented by a component 50 for use on a host 206.

WIT documents may contain a top level world definition in addition to the interface definitions. A world may be embodied as a complete description of both the imports and the exports of a component 50. A world can be considered an equivalent of a component type in the component model. Worlds can describe a specific component 50 and can be the basis for generating bindings. A guest language can use a world to determine which functions are imported, how they are named, and which functions are exported, in addition to their names. Worlds can contain any number of imports and exports and can be either a function or an interface.

wit-bindgen 207 may be a series of binding generators for languages that are compiled according to WebAssembly and use the component model. According to exemplary embodiments of the disclosure, wit-bindgen 207 can be used for converting 205 of the interface description to a desired programming language 208, for selecting 210 a runtime environment 31, and for compiling 209 of the generated vehicle software application 50. Bindings are described with *.wit files that specify imports and exports and facilitate reuse between binding definitions. Guest programs may be compiled in WebAssembly, for example. WIT definitions may be provided to describe imports and exports. The elements supported by WIT can be mapped directly to the component model that can be used to convert WebAssembly binary files generated by native compilers into a component 50. All imports into a WebAssembly binary file and all exports are described with WIT. A sample file may be provided as follows:

```
default world host {
  import print: func(msg: string)
  export run: func( )
```

This describes a “world” that describes both imports and exports that will be available to the WebAssembly component 50. In this case, the host 206 provides a print function and the component 50 itself provides an execution function. Functionality in WIT can also be organized into interfaces:

```
interface my-plugin-api {
  record coord {
    x: u32,
    y: u32,
  }
  get-position: func( ) −> coord
  set-position: func(pos: coord)
  record object {
    name: string,
    hp: u32,
    pos: coord,
  }
  objects: func( ) −> list<object>
  }
default world my-scene {
  import print: func(msg: string)
  import plugin: self.my-plugin-api
  export run: func( )
  }
```

Here, the my-plugin-api interface encapsulates a group of functions, types, etc. This can then be fully imported into the my-scene world via the plug-in name space. The structure of a WIT document and a WIT world impacts the bindings generated per language.

The end goal of wit-bindgen 207 is in particular to facilitate the creation of a component 50. Once a component 50 is created, it may be passed to any host runtime 31 for execution. A host 206 may be a data processing device 3 in accordance with exemplary embodiments of the disclosure. However, creation of a component 50 may not be natively supported by any language 208, so wit-bindgen 207 may form part of the process of creating a component 50. The general flow of the creation process of a component 50 for a compiled 208 language looks like the following, by way of example:

With wit-bindgen 207, source code for the language representing the bindings to the indicated APIs can be generated. This source code is then compiled by the compiler of the respective language in Wasm byte code. A common native target for the compilation is, for example, the “wasm32-wasi target”.

The wasm core module output may also be converted to a component 50, in particular, the wasm-tools component new subcommand. As a result, the native core wasm output can be incorporated and converted into the binary format of the component model. A component 50 can then be used to pass the binary file to a host run-time environment 31 for execution.

An important aspect in creating a component 50 is WASI. WebAssembly can also be used outside of browsers via this interface. Here, the wasmtime command starts a stand-alone runtime environment 31 for WebAssembly. The runtime environment 31 for WebAssembly can also be embedded in different languages 208.

wit-bindgen 207 is intended to facilitate the creation of a component 50, which must, however, also be executed. For example, when using the Rust programming language, “wasmtime crate” may be provided as an implementation of a native component run-time environment 31 that executes each WIT world. The selection 210 of runtime environment 31 may be made by wit-bindgen 207, according to exemplary embodiments of the disclosure.

According to exemplary embodiments of the disclosure, it may be provided that WebAssembly is used to create portable vehicle software applications 50 for different electrical/electronic architectures 2 (E/E architecture). Furthermore, the wasm interface description language (with) may be used to generate interfaces 4. In addition, use of the COVESA Vehicle Signal Specification semantics, COVESA Vehicle Service Specification semantics, or comparable semantics in with may be provided to generate vehicle software applications 50 that are independent of the E/E architecture 2 of the vehicle.

The COVESA Vehicle Signal and Service Specifications are an example of a vehicle signal and vehicle service specification 9 and provide a domain taxonomy for vehicle signals and vehicle services. In short, this means that by using a vehicle signal and service specification, a syntax for structured definition of vehicle signals and vehicle services, a catalog of signals and services associated with the vehicles can be provided. The vehicle signal and service specifications 9 may be used in automotive applications to communicate data 6 and functions 5 about the vehicle that are semantically well defined. A focus of the vehicle signals may be on vehicle signals in terms of the classic attributes, sensors 7 and actuators, wherein the raw data is communicated via vehicle buses and data 6 that is more associated to the infotainment system. A vehicle data specification 9 further allows a common name space to be used for communication and ultimately abstracts from the underlying details of the vehicle implementation.

The vehicle signal and service specifications 9 are in particular a common approach to describe vehicle data 6 and vehicle functions 5. It is an expandable data model and a catalog of tools. The Vehicle Signal and Service Specifications 9 from COVESA are specifically an industry-relevant data standard developed as part of the Connected Vehicle Interface Initiative (CVII), a collaboration between COVESA and W3C.

The above explanation of the embodiments describes the disclosure solely within the scope of examples. Of course, individual features of the embodiments can be freely combined with one another, if technically feasible, without leaving the scope of the disclosure.

What is claimed is:

1. A method for providing access from at least one vehicle software application to at least one of different vehicle systems, the vehicle systems comprising differently configured electrical/electronic architecture, the electrical/electronic architecture comprises at least one data processing device configured to execute the at least one vehicle software application for providing functions and/or data, and the electrical/electronic architecture configured to provide further vehicle functions and/or vehicle data in addition to the functions and/or data provided by the at least one data processing device, the method comprising:
providing the at least one vehicle software application, the at least one vehicle software application configured to be executed in runtime environments of the at least one data processing device; and
providing an access interface to the runtime environments for the at least one vehicle software application, the access interface defined by an interface description language,
wherein the access interface is defined by the interface description language for access to the functions and/or data and the further vehicle functions and/or vehicle data, and
wherein the access interface is defined suitable for the different configurations and independently of a specific configuration of the electrical/electronic architecture.

2. The method according to claim 1, wherein:
the electrical/electronic architecture comprises (i) at least one sensor and at least one actuator, and (ii) at least one further data processing device,
wherein the at least one further data processing device is used at least in part for at least semi-autonomous driving and/or for controlling the at least one actuator and/or for reading out the at least one sensor, and
wherein the at least one vehicle software application initiates control and/or reading.

3. The method according to claim 1, wherein:
the functions and the further vehicle functions comprise controls, regulations, and/or measurements internal to the vehicle system and/or connected to the vehicle system, and the data and further vehicle data comprise measurement data from at least one sensor internal to the vehicle system and/or a sensor connected to the vehicle system, and
the respective electrical/electronic architecture and the runtime environments comprise a switching function, to provide access to the further vehicle functions and/or vehicle data via the access interface defined independently of different configurations of the electrical/electronic architecture.

4. The method according to claim 1, wherein the at least one vehicle software application is provided by a WebAssembly byte code, as a Wasm component, to execute the at least one vehicle software application portably on different data processing devices.

5. The method according to claim 1, wherein:
the access interface is additionally defined by the interface description language using a vehicle signal and/or vehicle service specification for access to the functions and/or data and to the further vehicle functions and/or vehicle data,
the vehicle signal and/or vehicle service specification provides a syntax, to structure and standardize vehicle signals and vehicle services within a context of the at least one vehicle software application.

6. A method for providing at least one vehicle software application to at least one of different vehicle systems, the vehicle systems comprising differently configured electrical/electronic architecture, the electrical/electronic architecture comprising at least one data processing device configured to execute the at least one vehicle software application configured to provide functions and/or data, and the respective electrical/electronic architecture configured to provide further vehicle functions and/or vehicle data in addition to the functions and/or data provided by the data processing device, the method comprising:
providing a vehicle signal and/or a vehicle service specification;
converting the vehicle signal and/or the vehicle service specification to provide the vehicle signal and/or the vehicle service specification compatible for use in an interface description language;
generating at least one interface description for at least one access interface using the interface description language, the at least one access interface provided to access the functions and/or data and the further vehicle functions and/or vehicle data; and
generating the at least one vehicle software application using the at least one interface description generated.

7. The method according to claim 6, further comprising:
converting the interface description to use the interface description in a desired programming language including Java, C, C++, or Rust, to generate the at least one vehicle software application in the desired programming language;
compiling the generated vehicle software application; and
selecting a runtime environment of the at least one data processing device to execute the compiled vehicle software application on the selected runtime environment.

8. The method according to claim 1, wherein a computer program comprises instructions that, when the computer program is executed by a computer, cause the computer to perform the method.

9. A device for data processing, configured to perform the method according to claim 1.

10. A non-transitory computer-readable storage medium, comprising instructions that, when executed by a computer, cause the computer to perform the method according to claim 1.
